(19) United States
(12) Patent Application Publication
(10) Pub. No.: US 2024/0067027 A1
(43) Pub. Date: Feb. 29, 2024

(54) DYNAMIC DRIVER GENERATION FOR ENERGY MANAGEMENT SYSTEM

(71) Applicant: ECO STOR GmbH, Kirchheim (DE)

(72) Inventors: Robert Ulrich Bürger, Eching (DE); Kevin Maximilian Busch, München (DE); Florian Zeller, München (DE); Hubert Franz Merkle, Rechtmehring (DE)

(21) Appl. No.: 18/457,130

(22) Filed: Aug. 28, 2023

Related U.S. Application Data
(60) Provisional application No. 63/402,826, filed on Aug. 31, 2022.

(51) Int. Cl. B60L 53/62

(52) U.S. Cl. CPC B60L 53/62

(57) ABSTRACT

An energy management system can include one or more memory devices. The one or more memory devices can store instructions thereon, that, when executed by one or more processors, cause the one or more processors to receive a file including data points of an energy management device coupled to the one or more processors through an interface. The instructions can cause the one or more processors to generate a driver based on the data points of the file. The instructions can cause the one or more processors to execute the driver to read at least one of the data points or write to at least one of the data points via the interface.

### CROSS-REFERENCE TO RELATED PATENT APPLICATION

This application claims the benefit of, and priority to, U.S. Provisional Patent Application No. 63/402,826 filed Aug. 31, 2022, the entirety of which is incorporated by reference herein.

### BACKGROUND

The present application relates to energy management systems intended for use with stationary battery systems. In some applications, the stationary battery systems may utilize battery modules (e.g., arrays, packs, etc.) that have been repurposed from a previous use. For example, in the case of battery modules that have been utilized in electric vehicle (EV) applications, once they reach the end of their useful service life in a vehicle application (e.g., below approximately 80% of the original state of health), they can be redeployed for other energy storage applications such as providing stationary power storage for wind and solar energy systems or operating in a grid to provide grid services or take part in energy markets.

An energy management system can control the storage and distribution of energy. For example, the energy management system can cause a battery to charge or discharge based on any of a variety of factors, including power demands and available charge remaining, as well as providing other features in an energy storage and distribution scheme.

It would be advantageous to provide an improved energy management system, as discussed herein.

### SUMMARY

At least one aspect of the present disclosure is directed to a control system or an energy management system. The energy management system can include one or more memory devices storing instructions thereon, that, when executed by one or more processors, cause the one or more processors to receive a file including data points of an energy management device coupled to the one or more processors through an interface. The instructions can cause the one or more processors to generate a driver based on the data points of the file. The instructions can cause the one or more processors to execute the driver to read at least one of the data points or write to at least one of the data points via the interface.

The instructions can cause the one or more processors to generate a namespace, the namespace including an indication of a predefined variable. The instructions can cause the one or more processors to generate the driver to map a data point of the data points to an instance of the predefined variable. The instructions can cause the one or more processors to execute a software application based on the namespace, the software application configured to operate based on the instance of the predefined variable. The instructions can cause the one or more processors to read a value of the data point from the energy management device via the interface and provide the value to the instance of the predefined variable.

The instructions can cause the one or more processors to generate a namespace, the namespace including predefined variables. The instructions can cause the one or more processors to compare a name of a data point of data points of the file to names of the predefined variables. The instructions can cause the one or more processors to determine, based on the comparison, a match between the name of the data point and a name of a predefined variable of the predefined variables. The instructions can cause the one or more processors to generate, based on the match, the driver to map the data point of the data points to an instance of the predefined variable.

The instructions can cause the one or more processors to generate the driver to map between the data points to variables, wherein at least one variable of the variables is an object defined based on a class. The class can define attributes for the object that describe the data point.

The instructions can cause the one or more processors to generate the driver to map between the data points and variables. At least one variable of the variables can be an object defined based on a class, the class defining attributes for the object describing a data point of the data points. An attribute of the attributes can include a rate to acquire a value of the data point at. The instructions can cause the one or more processors to execute the driver to read the value of the data point at the rate defined in the attribute of the object.

The instructions can cause the one or more processors to generate the driver to map between the data points and variables. At least one variable of the variables can be an object defined based on a class, the class defining attributes for the object describing a data point. An attribute of the attributes can include a rate to write a value of the data point to a software application. The instructions can cause the one or more processors to execute the driver to write the value of the data point to the software application at the rate defined in the attribute of the object.

The instructions can cause the one or more processors to receive the file, the file including an indication that a first data point of the data points and a second data point of the data points are part of a block. The instructions can cause the one or more processors to generate, based on the indication that the first data point and the second data point are part of the block. The variables can include a first variable, wherein the first variable is a first object defined based on a first class, the first class defining first attributes for the first object, the first attributes can include a block identifier of the block. The variables can include a second variable, wherein the second variable is a second object defined based on the first class or a second class, the first class or the second class defining a second attributes for the second object, the second attributes including the block identifier of the block. The instructions can execute the driver to transmit, via the interface, one request to the energy management device to read the block indicated by the block identifier, the block include the first data point and the second data point and receive a value of the first data point and a value of the second data point via the interface responsive to the one request.

The instructions can cause the one or more processors to search the file to determine that a first data point and a second data point of the data points do not include a block identifier. The instructions can cause the one or more processors to identify that the first data point and the second data point include consecutive addresses. The instructions can cause the one or more processors to generate, responsive to an identification that the first data point and the second data point include the consecutive addresses, a first variable for the first data point, the first variable including an attribute including an identifier of a block. The instructions can cause the one or more processors to generate, responsive to an identification that the first data point and the second data point include the consecutive addresses, a second variable for the second data point, the second variable including an attribute including the identifier of the block.

The instructions can cause the one or more processors to compare a name of a data point indicated in the file to names of predefined variables. The instructions can cause the one or more processors to determine, based on the comparison, that there is no match between the name of the data point and the names the predefined variables. The instructions can cause the one or more processors to instantiate a variable in a class for the data point responsive to a determination that there is no match between the name of the data point and the names of the predefined variables. The instructions can cause the one or more processors to populate attributes of the variable based on data of the file for the data point.

The instructions can cause the one or more processors to identify an encoding of a value of a data point of data points based on the file. The instructions can cause the one or more processors to generate an instance of a variable in a class, the class including attributes. The instructions can cause the one or more processors to store an indication of the encoding in an attribute of the attributes. The instructions can cause the one or more processors to execute the driver to read the encoding from the attribute and decode the value of the data point based on the encoding.

At least one aspect of the present disclosure is a method. The method can include receiving, by one or more processing circuits, a file including data points of an energy management device coupled to the one or more processors through an interface. The method can include generating, by the one or more processing circuits, a driver based on the data points of the file. The method can include executing, by the one or more processing circuits, the driver to read at least one of the data points or write to at least one of the data points via the interface.

The method can include generating, by the one or more processing circuits, a namespace, the namespace including an indication of a predefined variable. The method can include generating, by the one or more processing circuits, the driver to map a data point of the data points to an instance of the predefined variable. The method can include executing, by the one or more processing circuits, a software application based on the namespace, the software application configured to operate based on the instance of the predefined variable. The method can include reading, by the one or more processing circuits, a value of the data point from the energy management device via the interface and provide the value to the instance of the predefined variable.

The method can include generating, by the one or more processing circuits, a namespace, the namespace including predefined variables. The method can include comparing, by the one or more processing circuits, a name of a data point of data points of the file to names of the predefined variables. The method can include determining, by the one or more processing circuits, based on the comparison, a match between the name of the data point and a name of a predefined variable of the predefined variables. The method can include generating, by the one or more processing circuits, based on the match, the driver to map the data point of the data points to an instance of the predefined variable.

The method can include generating, by the one or more processing circuits, the driver to map between the data points to variables, wherein at least one variable of the variables is an object defined based on a class. The class can define attributes for the object that describe the data point. The method can include generating, by the one or more processing circuits, the driver to map between the data points and variables. At least one variable of the variables is an object defined based on a class, the class defining attributes for the object describing a data point of the data points. An attribute of the attributes can include a rate to acquire a value of the data point at. The method can include executing, by the one or more processing circuits, the driver to read the value of the data point at the rate defined in the attribute of the object.

The method can include generating, by the one or more processing circuits, the driver to map between the data points and variables. At least one variable of the variables is an object defined based on a class, the class defining attributes for the object describing a data point. An attribute of the attributes can include a rate to write a value of the data point to a software application. The method can include executing, by the one or more processing circuits, the driver to write the value of the data point to the software application at the rate defined in the attribute of the object.

The method can include receiving, by the one or more processing circuits, the file, the file including an indication that a first data point of the data points and a second data point of the data points are part of a block. The method can include generating, by the one or more processing circuits, based on the indication that the first data point and the second data point are part of the block, variables. The variables can include a first variable, wherein the first variable is a first object defined based on a first class, the first class defining first attributes for the first object, the first attributes including a block identifier of the block. The variables can include a second variable, wherein the second variable is a second object defined based on the first class or a second class, the first class or the second class defining second attributes for the second object, the second attributes including the block identifier of the block. The method can include executing, by the one or more processing circuits, the driver to transmit, via the interface, one request to the energy management device to read the block indicated by the block identifier, the block including the first data point and the second data point and receive a value of the first data point and a value of the second data point via the interface responsive to the one request.

The method can include searching, by the one or more processing circuits, the file to determine that a first data point and a second data point of the data points do not include a block identifier. The method can include identifying, by the one or more processing circuits, that the first data point and the second data point include consecutive addresses. The method can include generating, by the one or more processing circuits, responsive to an identification that the first data point and the second data point include the consecutive addresses, a first variable for the first data point, the first variable including an attribute including an identifier of a block. The method can include generating, by the one or more processing circuits, responsive to an identification that the first data point and the second data point include the consecutive addresses, a second variable for the second data point, the second variable including an attribute including the identifier of the block.

The method can include comparing, by the one or more processing circuits, a name of a data point indicated in the file to names of predefined variables. The method can include determining, by the one or more processing circuits, based on the comparison, that there is no match between the name of the data point and the names the predefined variables. The method can include instantiating, by the one or more processing circuits, a variable in a class for the data point responsive to a determination that there is no match between the name of the data point and the names of the predefined variables. The method can include populating, by the one or more processing circuits, attributes of the variable based on data of the file for the data point.

One aspect of the present disclosure is directed to an energy management system. The energy management system can include an interface. The energy management system can include a data processing system including one or more memory devices storing instructions thereon and one or more processors to execute the instructions. The one or more processors can receive a file including data points of an energy management device coupled to the one or more processors through an interface. The one or more processors can generate a driver based on the data points of the file. The one or more processors can execute the driver to read at least one of the data points or write to at least one of the data points via the interface.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example an energy management system including a data processing system that dynamically generates a driver to interface with an energy management device.

FIG. 2 is an example of a variable class that can be utilized by a driver.

FIG. 3 is an example method of generating a driver for an energy management device.

FIG. 4 is an example method of implementing a driver generated by an energy management device.

FIG. 5 is an example method of running a driver to control a battery.

FIG. 6 is an example method of dynamically generating a driver to interface with an energy management device.

FIG. 7 is an example computing architecture of a data processing system.

### DETAILED DESCRIPTION

Following below are more detailed descriptions of various concepts related to, and implementations of, methods, apparatuses, and systems that dynamically generate a driver. The various concepts introduced above and discussed in greater detail below may be implemented in any of numerous ways.

An energy management system (e.g., data processing system, computer, controller, server) can run software applications or software products that consume data collected from an energy management device (e.g., such as a battery system, a battery, a solar power system, a photovoltaic system, a generator, etc.). The energy management system can read values from the data points of the energy management device or write values to the data points of the energy management device. The data points can be battery state of charge, battery temperature, battery charge rate, photovoltaic current or voltage, a command to discharge a battery, a command to charge a battery, etc.

When a new energy management device is coupled with the energy management system, the energy management system can implement new interfaces to connect with the new energy management devices via new physical network protocols. The energy management system can add interface code directly into the existing software applications. However, adding the interface directly into the software application can require individualized programming of the interface for the specific software product. Individually programming each software product to implement new interfaces can require significant amounts of excess coding time, development resources, or operational resources (e.g., computer resources, memory resources, processor resources, energy resources). Furthermore, the software applications may need to be redeployed. For example, during software commissioning or maintenance, the software applications may need to be changed to meet the requirements of the new interface with the new energy storage system, especially when the original interface was not available for hardware-in-the-loop tests before commissioning.

Furthermore, multiple software applications can consume the data of an energy management device. In this regard, multiple software applications may all need access to the same data points. These software products can all interface with each other via a standard interface format. However, the interface code of each software application to interface the software application with the energy management device may be in a different format than the standard interface format. This can require data conversion to convert from the format of the interface code into the format of the software applications. This can use substantial amounts of processing, memory, and power resources. Furthermore, the energy management system can receive a high volume of data (e.g., kilobytes, megabytes, gigabytes) at a high velocity or rate (e.g., kilobits per second (Kbps), megabits per second (Mbps), gigabits per second (Gpbs)) over one or more communication mediums or channels that couple the energy management system to the energy management device. The energy management system may use excessive computing resources and network resources to handle the volume of data and the rate at which the data is received.

To solve for these, and other technical issues, this technical solution can include automatically generating drivers to interface the energy management system with energy management devices. The energy management system, when coupled with a new energy management device or a new physical interface, can automatically generate a driver that interfaces existing applications with the new energy management device or the new physical interface. The energy management system can receive a database or file including parameters defining an interface with the new energy management device. A piece of software, e.g., an automatic driver generator, can produce a new driver between an existing software application and an energy management device based on the file. Instead of relying on redeployment or redesign of the existing software application, the drivers can be automatically generated and implemented by the driver generator, allowing the existing software applications to implement or switch to new drivers and interface with new energy management devices at runtime, e.g., without requiring redeployment of an application or system. This can result in significant amounts of savings in processing resources, memory resources, power consumption resources, etc. Furthermore, this can result in quick or rapid deployment of drivers for the energy management system (e.g., within tens of minutes, within minutes, within seconds) to interface new energy management devices with existing software applications. The energy management system can generate and deploy drivers without requiring re-design, commissioning, or testing of existing software applications.

The file input to the driver generator can be a data point lists or other description of the interface to be implemented for the software applications, expanded by additional information describing the use of the data points in the software applications. The automatic driver generator can transform the data points of the point list into a format which can be used by the software product directly. The driver generator can output a driver, a piece of executable code or an executable software component that can control an external device, such as the energy management device, with or without any hardcoded software component.

For example, the driver generator can implement a namespace of predefined variables. The predefined variables can be objects instantiated or defined based on a class structure. Classes of the class structure can be predefined. The class can define attributes that define the characteristics of a data point, data points, or each data point. Responsive to receiving a file including data points of a new energy management device, the energy management system can compare names of the data points of the file to names of the predefined variables of the namespace. Responsive to identifying matches between the names, the driver generator can generate the driver to write data values read from the data points to instances of the predefined variables. Existing software applications can execute based on the namespace to operate based on the instances of the predefined variables. Furthermore, the driver generator can include a class to dynamically define and represent data points that are not included or represented in the namespace. For example, responsive to identifying that no matches exist, the energy management system can instantiate the class that represents new types of data points, and populate the attributes of the instance of the class with data retrieved from the data point file.

Furthermore, the driver can provide efficient data handling and reduce network traffic. The driver can distribute data to multiple different software applications, removing the need to have duplicate individually programmed interfaces for the various software applications. This can reduce internal duplicative communication. Furthermore, the variables can include attributes identifying blocks that the data points are a part of. The driver can use the identified blocks in the variables to block read from the energy management device or block write to the energy management device, e.g., read multiple data points with a single request or write to multiple data points with a single request. These techniques can significantly reduce the amount of data messages that the driver transmits to the energy management device since only a single request is needed to read multiple data points instead of requiring the driver to individually send a request for each data point to be read. Furthermore, because the entire block may be transmitted by the energy management device to the data processing system in a single message, only one message header or set of metadata may be required for the block message. In contrast, if each data point is transmitted in an individual message to the driver, each message may include a message header or set of metadata.

The driver generator can establish new interfaces with energy management devices based on input from non-programming users (e.g., users who may not have programming knowledge, experience, or training). Users can edit or manipulate the data point files via toolsets or programs (such as a spreadsheet editor application) to define or make changes to the driver generated from the data point file. Changes in data protocols can be adapted rapidly, and new protocol versions can be adapted and implemented. Furthermore, the driver generator can reduce the possibility of copy and paste errors or design errors when programming.

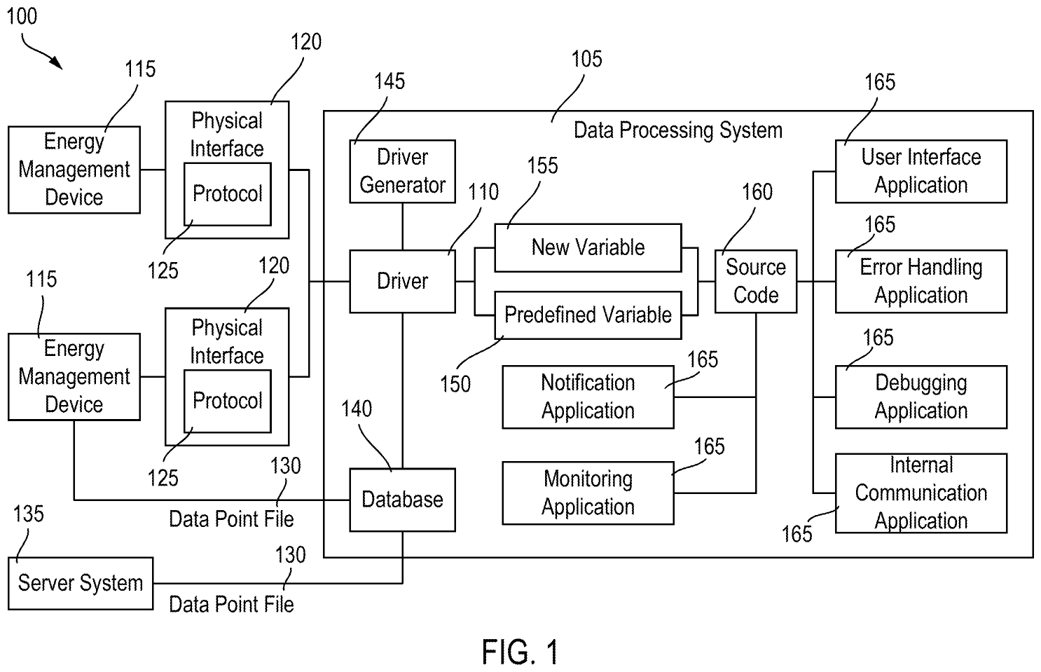

Referring now to FIG. 1, among others, an example energy management system 100 including a data processing system 105 that dynamically generates a driver 110 to interface with an energy management device 115 is shown. The energy management system 100 can be a system that manages the generation of energy, the storage of energy, or the distribution of energy. For example, the energy management system 100 can include or be connected or coupled with at least one energy management device 115. The energy management device 115 can be a battery, battery pack, battery system, inverter, photovoltaic system, stationary power device, hot energy storage device, fire detection, response or prevention device, uninterruptible power supply (UPS), air conditioning system to cool energy storage devices, etc. The energy management system 100 can control the energy management devices 115 to store energy and provide energy to loads of a system (e.g., a house, an electric vehicle, a school, a hospital, an appliance, an energy grid, an electric grid, an electric utility, a public grid, etc.).

The energy management system 100 can include at least one data processing system 105. The data processing system 105 can be a system that manages or controls the energy management devices 115. The data processing system 105 can be a control system, a controller, a server system, a desktop computer system, a microprocessor, microcontroller, distributed processing system, an on-premises system, an off-premises system, etc. The data processing system 105 can interface with the energy management devices 115 to read values, measurements, operational data, indicators, statuses, faults, etc. from data points the energy management devices 115. The data processing system 105 can write values, setpoints, control commands, or other information to data points of the energy management devices 115 to cause batteries to charge, cause batteries to discharge, cause an amount of power provided to a load to be at or near a setpoint, etc.

The data processing system 105 can be coupled with the energy management devices 115 via at least one physical interface 120. The data processing system 105, processors, or other electrical circuits or components can be coupled, connected, or interfaced with the energy management device 115. The physical interface 120 can be a physical circuit, switch, transmitter, transceiver, transceiver, plug, or other electrical circuit that electrically connects or couples the data processing system 105 with the energy management devices 115. The physical interfaces 120 can implement a network or communication protocol 125. The protocol 125 can be Modbus/TCP, BACnet, a local area network (LAN), controller area network (CAN), or any other communication or network protocol.

The data processing system 105 can receive at least one data point file 130. The data point file 130 can be developed, defined, or created by a manufacturer of the energy management device 115. The data point file 130 can be a specification or a set of specifications of the energy management device 115. The data point file 130 can include information that explains the techniques or mechanisms for communicating with the energy management device 115. The data point file 130 can include information that describes the data points, the addresses of the data points, or the registers of the data points of the energy management device 115. The data point file 130 can include at least one data point of the energy management device 115. The data point file 130 can include a set or group of data points of the energy management device 115. The data points can be measurement points of a sensor of the energy management device 115 (e.g., a temperature sensor, a voltage sensor, a current sensor, a power meter, etc.). The data points can be states of the energy management device 115 that can be monitored. The data points can be values calculated by the energy management device 115 from the operating setpoints, operating data, or sensor measurements of the energy management device 115. The measurement points of the energy management device 115 can indicate battery temperature, battery state of charge, photovoltaic voltage, air conditioner temperature, error states, fault indicators, etc. The data points can be control points, e.g., a discharge setpoint, a power setpoint, a charging setpoint, a direct current (DC) power setpoint, etc. The data processing system 105 can transmit values to the data points to cause the energy management device 115 to operate based on the control points. The data point file 130 can identify information to be communicated to the energy management device 115. The data point file 130 can indicate a communication protocol used by the energy management device 115, e.g., Modbus/TCP, CAN, BACnet, etc.

The data point file 130 can be a cell sheet, such as an MICROSOFT EXCEL Open Extensible Markup Language (XML) Spreadsheet (XLSX), a Comma-Separated Value (CSV) file, or an XML file. The data point file 130 can be a text file. The data point file 130 can be any type of data structure, file, database, or storage mechanism. The data processing system 105 can receive the data point file 130 and store the data point file 130 or data of the data point file 130. For example, the data processing system 105 can store or maintain at least one database 140. The data processing system 105 can read the data from the data point file 130 and store the data in the database 140. For example, the data processing system 105 can integrate or ingest the data point file 130 into the database 140. In some implementations, a user can add additional pieces of information or parameters for the data points into the data point file 130 or directly into the database 140. The data processing system 105 can read information out of the data point file 130 and add the information in a predefined or standardized format to the database 140.

The database 140 can be a copy of the data point file 130. The database 140 can be a relational database management system (RDBMS), a Structured Query Language (SQL) database, a table, or any other type of database. The data processing system 105 can translate or store the data point files 130 into the database 140 in a common or predefined format. The driver generator 145 can be configured to read and execute based on the format that the data point files 130 are stored in the database 140. The driver generator 145 can be configured to read and execute based on the format that the data point files 130 are originally defined in.

The data point file 130 can specify data points of the energy management device 115. The data point file 130 can parameterize the interface between the energy management device 115 and the data processing system 105. For example, the data point file 130 can parameterize one, multiple, or each data point of the data point file 130. The data point file 130 can specify the information that the energy management device 115 can transmit and the information that the energy management device 115 can receive. The data point file 130 can parameterize an interface with the energy management device 115 in a data structure, such as a parameterization sheet.

The data point file 130 can be stored by an energy management device 115. A manufacturer, programmer, or designer of the energy management device 115 can generate the data point file 130 to describe the points of the energy management device 115 and store the data point file 130 on the energy management device 115 when the energy management device 115 is being manufactured, programmed, flashed with instructions or firmware, etc. The energy management device 115 can transmit, send, or communicate the data point file 130 to the data processing system 105. For example, responsive to being electrically coupled with the data processing system 105, the energy management device 115 can transmit the data point file 130 to the data processing system 105. The data processing system 105 can receive the data point file 130 from the energy management device 115. In some implementations, the data processing system 105 can send a query message or request message to the energy management device 115, causing the energy management device 115 to respond with the data point file 130.

The data point file 130 can be stored on a server system 135. The data point file 130 can be stored in a database of multiple other data point files 130 for different energy management devices 115. The server system 135 can be a web server that provides access to a data point file 130, or a repository of data point files 130. The server system 135 can push the data point file 130 to the data processing system 105 responsive to an indication that the energy management device 115 has been purchased by an owner or operator of the energy management system 100. Furthermore, the data processing system 105 can retrieve the data point file 130 from the server system 135. For example, a user can provide a location or address of the data point file 130, such as a uniform resource locator (URL) of the data point file 130 on the server system 135. In some implementations, the data processing system 105 can receive the location or address of the data point file 130 from the energy management device 115. Based on the address, the data processing system 105 can retrieve the data point file 130 from the server system 135. The data processing system 105 can receive a name or model number of the energy management device 115 from the energy management device 115 or via a user input via a graphical user interface. Based on the name, the data processing system 105 can search or query the server system 135 for the data point file 130 associated with the name of the energy management device 115.

The data processing system 105 can include at least one driver generator 145. The driver generator 145 can be or include a piece of code, instructions, a software module, a physical circuit, a group of processing components, etc. The driver generator 145 can generate at least one driver 110. The driver generator 145 can generate the driver 110 to communicate with the energy management devices 115 via various interfaces 120 such as Ethernet interfaces. The interfaces 120 can run Modbus/TCP protocols 125. However, the driver generator 145 can be implemented for a variety of communication protocols 125 similar to Modbus/TCP, e.g., communication protocol 125 that that include data point lists and addressing structures similar to Modbus/TCP. The driver generator 145 can be implemented for a variety of communication protocols 125 that are not similar to Modbus/TCP.

The driver generator 145 can generate the driver 110 based on the data point file 130. For example, the driver generator 145 can generate the driver 110 based on the data point file 130 directly, or the data point file 130 loaded or saved into the database 140. The driver generator 145 can generate the driver 110 based on the data points of the data point file 130. For example, the driver generator 145 can read all of the various parameters describing each data point in the data point file 130, and generate the driver 110 based on the parameters for each data point. The driver 110 can receive values, measurements, characters, or other information from a data point of the energy management device 115 and write the values, measurements, characters, or other information to the variables 150 or 155.

In some implementations, the driver 110 can write the information into attributes of the variables 150 or 155. Each variable 150 or 155 can store an address or register indicator of the corresponding data point of the energy management device 115. The driver 110 can transmit or send a request message identifying the corresponding address or register indicator to retrieve the value of the data point along with a request to read the data point. The driver 110 can store the received value in the variable 150 or 155. The driver 110 can read the address or register indicator from the variable 150 or 155, along with a value to be written to the corresponding data point. The driver 110 can send or transmit the value to the energy management device 115 along with the address or register to write the value to and a command or indication to write the value to the data point.

The driver 110 generated by the driver generator 145 can be a piece of executable code or set of instructions. The driver 110 can be or include a JavaScript Object Notation (JSON) file. The driver 110 can include at least one JSON file. The driver 110 can translate, map, or provide values of the data points of the energy management device 115 to variables 150 and 155 that source code 160 executes on. The data processing system 105 can execute the driver 110. For example, the data processing system 105 can execute the driver 110 to read at least one of the data points of the energy management device 115 via the interface 120. The data processing system 105 can execute the driver 110 to write to the energy management devices 115. For example, the driver generator 145 can generate or instantiate variables 150 and 155. In some implementations, the driver 110 can generate or instantiate the variables 150 and 155. In some implementations, the source code 160 generates or instantiates the variables 150 and 155 responsive to an instruction received from the driver 110 or the driver generator 145. There may be no limitations on the data points that the energy management devices 115 can have or include. In this regard, the driver 110 can utilize the predefined variables 150 and the new variables 150 to provide the source code 160 with access to the data points. The driver 110 can make the data points of the energy management devices 115 available to the source code 160 through the variables 150 and 155. The driver 110 can apply the data points to the variables 150 or 155. The variables 155 and 150 can be generated at or during runtime in the source code 160.

The driver generator 145 can cause the driver 110 to be implemented in, or integrated into, the source code 160. The driver 110 can include some or all of the information necessary for controlling a particular energy management device 115. For example, the driver generator 145 can be included and used within one or multiple programs run by the data processing system 105. For example, the driver 110 can be a program instance that runs in the source code 160. The driver 110 can enable automatic control of the energy management device 115.

The driver 110 can perform device communication and control for the energy management device 115. Furthermore, the driver 110 can perform various functions such as display a device state. For example, the driver 110 can read a device state from a data point of the energy management device 115 and cause a user interface, or an application 165, to display the state. The variables 150 or 155 can include attributes that indicate whether or not a value or state for a particular data point should be displayed, and the driver 110 can use the attributes to determine whether or not to cause the value or state to be displayed or visualized. The variables 150 or 155 can include an attribute to store values or states of the data point in a database. The driver 110 can cause values or states read from the data point of the energy management device 115 in a database responsive to reading the attribute to store the value or state in the data point from the variable 150 or 155 for the data point. The variables 150 or 155 can indicate attributes that indicate to send a notification in the event of an error occurring as indicated by a data point of the energy management device 115. Responsive to reading the attribute to send the notification, the driver 110 can cause a notification to be transmitted responsive to reading an error from the data point of the energy management device 115. The variables 150 or 155 can indicate attributes that a data point is used for debugging. Responsive to reading the attribute to use the data point for debugging, the driver 110 can cause the value of the data point to be recorded in a log file. The variables 150 or 155 can include attributes that indicate that a data point should be transmitted to another instance within a program. The attributes can indicate what program or instance needs the data point or what interfaces that the driver should be transmitted through. Responsive to reading the attribute to transmit the data point, the driver can transmit the data point value to a point or through an interface specified in the attributes.

The driver generator 145 can cause the variables 150 or 155 to be generated, instantiated, or filled with attributes based on the data points of the data point file 130. In some implementations, the variables 150 already exist, and the driver generator 145 adds additional attributes to the variables 150. To link the data points of the data point file 130 and the predefined variables 150, a fixed namespace can defined and made available to the source code 160. The namespace can be referenced, included, or identified in the data point file 130. For example, the predefined variables 150 can be defined based on a namespace. The namespace can be fixed, e.g., unchanging or predefined. The driver generator 145 can generate, instantiate, or activate a name space. The namespace can be a set or group of symbols or signs that identify data, attributes, objects, classes, or functions of various kinds. The name space can include indications of one, multiple, or a set of the predefined variables 155. The namespace can be provided to the source code 160 or the applications 165. The source code 160 and/or the various software applications 165, can execute based on the namespace. In this regard, the source code 160 can be configured to execute based on the predefined variables 150. The source code 160 or the application 165 can be coded, written, or configured to use the namespace. When the source code 160 or the applications 165 are written or modified, an integrated development environment (IDE) can execute based on the namespace. For example, autocompletion functions of the IDE, can recommend predefined variables 150 to a user when the user begins typing the name of a predefined variable 150 in the IDE.

The driver generator 145 can determine, based on the data points of the data point file 130, to generate, instantiate, or fill at least one predefined variable 150 with attributes for at least one of the data points. For example, at least one software application 165 can execute to operate based on the instance of the predefined variables 150. The driver 110 can map or translate between the data points of the energy management device 115 and the predefined variables 150. For example, the driver 110 can read values of the data points of the energy management device 115, and write the values to the predefined variables 150 or to attributes of the predefined variables 150. Similarly, the driver 110 can read values of the predefined variables 150 (e.g., values written to the predefined variables 150 by the source code 160 or the applications 165. The driver 110 can, in return, transmit the values to the corresponding data points of the energy management devices 115 via the physical interface 120.

The driver generator 145 can generate the predefined variables 150 or add or fill the variables 150 with attributes by comparing the data points of the data point file 130 to the predefined variables. The driver generator 145 can execute to compare names or identifiers of the data points of the data point file 130 to names or identifiers of classes or class types of the variables 150. For example, the driver generator 145 can compare numbers, binary values, characters, character strings, etc. Responsive to identifying a match between a name of a data point and a name of a class of a predefined variable 150, the driver generator 145 can generate or instantiate the predefined variable 150 or an instance of the predefined variable 150 for the corresponding data point. The driver generator 145 can determine that a match is identified if there is an exact or complete match between the name of a data point and a name of a predefined variable 150. The driver generator 145 can determine that a match is identified if a percentage of matching characters, or a number of matching characters between the name of the data point and the name of the predefined variable 150 satisfies a threshold (e.g., meets or exceeds the threshold). The predefined variables 150 can provide a standard interface for the various software applications 165 to communicate with the energy management device 115. The predefined variables 150 can provide a standard interface for the various software applications 165 to communicate with each other.

The driver 110 can generate the new variables 155 to handle new data types that are not defined in the namespace. The new variable class can enable new data points to be attached. For example, when a data point of the data point file 130 does not match any of the predefined variable classes available in the namespace, the driver 110 can generate a new variable based on a specific class for handling new data types. The new variable 155 can be generated at runtime of the driver 110, the source code 160, or the applications 165. The variable class can overcome the requirements or limitations of IDE name spacing, and allow for the data processing system 105 to handle new data points that the system cannot map into an existing predefined variable class. The new class can include multiple different attributes that can be populated by the driver generator 145. The attributes can be empty attributes that are undefined, and can store all of the values or parameters of the data point file 130 that describe a particular data point. In some implementations, the majority or all of the data points are linked or mapped to the predefined variables 150. A minority, or a portion of the data points, can be mapped to new variables 155, e.g., when the driver generator 145 cannot map or link data points of the data point file 130 to the predefined variables 150.

For example, responsive to a determination that a name or identifier of a data point of the data point file 130 does not match any of the names or identifiers of the predefined variables of the namespace, the driver generator 145 can generate or instantiate the new variable 155 according to a new variable class for handling data points that do not map or link into the predefined variables 150. The driver generator 145 can compare a name of a data point indicated in the data point file 130 to the names of the predefined variables 150. Based on the comparison, the driver generator 145 can determine that there is no match between a name or identifier of a specific data point and any or a set of the names or identifiers of the predefined variables 150. The driver generator 145 can instantiate the new variable 155 according to a class to provide or link the specific data point. The driver generator 145 can instantiate the new variable 155 responsive to a determination that there is no match between the name of the data point and the plurality of names of the predefined variables 150. The new variable 155 can be an object including an attribute or a set of attributes. The driver generator 145 can read the parameters or values of the data point file 130 associated with the specific data point, and populate the attributes of the new variable 155 with the parameters or values.

The data points can have data values in a variety of data types that can work directly with the predefined variables 150. For example, the some data points can have data values that are eight bit integers, floating point numbers, doubles, or any other data point. The driver generator 145 can generate predefined variables 150 for the data points that include attributes that identify or specify the data type of the value of the data points. However, some types of data values for data points may not have a data type that corresponds with an available data type of the predefined variables. For example, a data value of a particular data point can have a specific scaling factor, byte order, bit order, etc. The data point file 130 can define the particular data type, scaling factor, byte order, or bit order for the data point. In some implementations, the data point file 130 is generated by a manufacturer to include the particular data type of the data point. In some implementations, a user, via a graphical user interface, can edit the data point file 130 to add a column, row, or other data element to store the data type (or any other piece of information). When the driver generator 145 generates the driver 110, the driver generator 145 can generate a variable 155 or 150 to include an attribute that stores the data type of the data point indicated by the data point file 130.

The data processing system 105 can include source code 160. The source code 160 can be the instructions or code run by the data processing system 105 to operate, such as the various applications 165, an operating system, operating code, etc. The applications 165 can include various applications that operate based on the variables 155 or the predefined variables 150. The applications 165 can operate based on the values of the data points input or written into the variables 150 and 155 by the driver 110. The applications 165 can write values to the data points of the energy management device 115 by writing values to the new variables 155 or the predefined variables 150.

The data processing system 105 can include at least one user interface application 165. The user interface application 165 can generate graphic user interface elements, e.g., indicators, numbers, charts, graphs, trends, etc. based on the variables 155 or the variables 150. The data processing system 105 can include at least one error handling application 165. The error handling application 165 can collect or aggregate errors of the energy management devices 115 indicated by the variables 150 and 155. For example, a value of a specific variable 150 or 155 can be a fault or error indicator. The error handling application 165 can generate a graphical user interface that displays the fault or error indicators, timestamps indicating when the faults or errors occurred, downtime of the energy management devices 115, or other metrics.

The data processing system 105 can include at least one debugging application 165. The debugging application 165 can interface with the energy management devices 115 and debug the energy management devices 115. The debugging application 165 can identify bugs or errors in the code, instructions, or configuration of the energy management devices 115. The debugging application 165 can read values of the data points of the energy management device 115 via the variable 150 or 155 and use the values to identify bugs or errors. The debugging application 165 can update operating parameters or configurations of the energy management devices 115 by writing values to data points of the energy management devices 115 via the variables 155 or 150.

The data processing system 105 can include an internal communication application 165. The internal communication application 165 can transmit information internally within the data processing system 105 to a variety of applications, components, interfaces, etc. Furthermore, the driver 110 can receive information via the internal communication application 165 to be written to the energy management device 115. The data processing system 105 can include at least one notification application 165. The notification application 165 can generate notifications based on the variables 150 or 155. For example, the notification application 165 can generate a notification and display the notification on a graphical user interface generated by the user interface application 165. The notification application 165 can cause a notification to be displayed on a smartphone of a user. The notification application 165 can cause a notification to be transmitted to a phone number via a short message service (SMS). The notification application 165 can cause a notification to be transmitted via email to an email address. The data processing system 105 can include at least one monitoring application 165. The monitoring application 165 can monitor data values of the data points of the energy management devices 115. For example, the monitoring application 165 can receive values of the data points via the variables 155 or 150. The monitoring application 165 can track trends of the data points of the energy management device 115, e.g., trends of temperatures, voltages, states of charge, etc. of a battery or battery system. The monitoring application 165 can compare the values read from the data points of the energy management device 115 to thresholds. If a value meets or exceeds a threshold, the monitoring application 165 can cause the notification application 165 to generate and provide a corresponding notification. If a value meets or exceeds a threshold, an application 165 can transmit a command or setpoint to the energy management device 115 to control the operation of the energy management device 115 via the variables 155 or 150. For example, if a battery temperature exceeds a temperature, the application 165 can cause a notification to be transmitted to or a command transmitted to the energy management device 115 to stop the battery from charging.

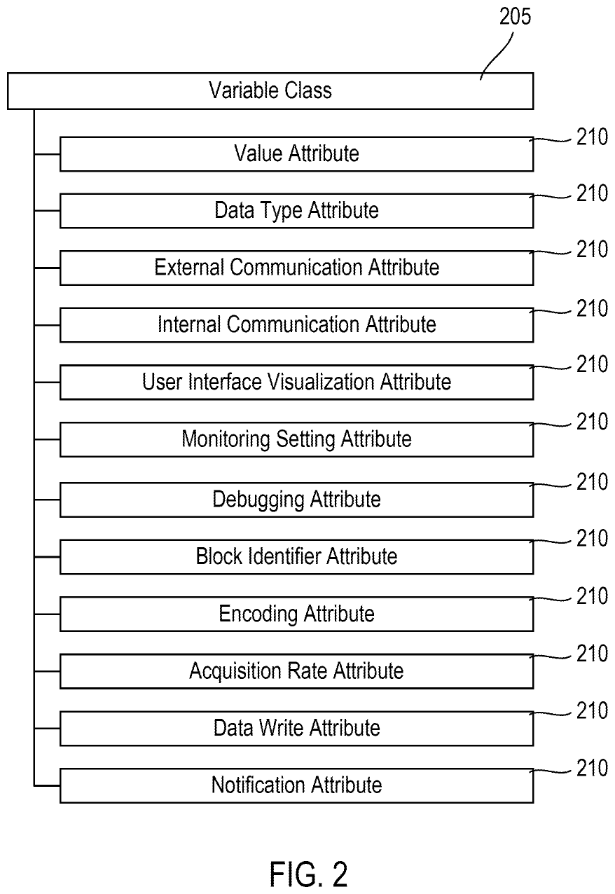

Referring now to FIG. 2, among others, a variable class 205 that can be utilized by a driver 110 is shown. The variable class 205 can be a class used to implement one of the new variables 155 or one of the predefined variables 150. For examples, the variables 150 or 155 can be objects instantiated or implemented based on the variable class 205. The variable class 205 can be part of the namespace for the driver 110. The driver generator 145 can generate the driver 110 to map or link the data points of the energy management device 115 to the variables 155 or 150. In particular, the driver generator 145 can map or link values of the data points with attributes of the variables 155 or 150. At least one of the attributes 210 can store or represent a value read from the corresponding data point or a value to be written to the corresponding data point.

The class 205 can include at least one data type attribute 210. The data type attribute 210 can define the specific data type of the corresponding data point of the energy management device 115. The data type attribute 210 can define the particular data type (e.g., unsigned eight bit integer, signed eight bit integer, float, double), scaling factor, byte order, or bit order for the data point. The class 205 can include at least one external communication attribute 210. The external communication attribute 210 can indicate the type of communication protocol 125 for communicating with the energy management device 115 or the protocol used by the energy management device 115 specific to the data point. The external communication attribute 210 can indicate Modbus/TCP, BACnet, a local area network (LAN), controller area network (CAN), or any other communication or network protocol. The external communication attribute 210 can indicate a Modbus register, Modbus function code, an offset factor, a data type (e.g., float, integer, Boolean). The attributes 210 can include an internal communication attribute 210. The internal communication attribute 210 can indicate the communication mechanism used to communicate the data point internally within the data processing system 105 or within the source code 160. For example, the internal communication attribute 210 can indicate MQTT, user datagram protocol (UDP), or any other protocol.

The attributes 210 can include a user interface visualization attribute 210. The user interface visualization attribute 210 can indicate that the data value or state of the data point should be visualized in a user interface. For example, the driver 110 or user interface application 165 can read the user interface visualization attribute 210 and can cause the user interface application 165 to display the value or state of the data point. The user interface visualization attribute 210 can indicate specified users that the data point should be displayed for, that the data point should only be displayed when activated by a user, and a unit definition to use when displaying the data point.

The attributes 210 can include a monitoring setting attribute 210. The monitoring setting attribute 210 can indicate that data point should be monitored. The driver 110 or the monitoring application 165 can monitor the data point responsive to reading the monitoring setting attribute 210. The monitored data point can be stored in a database internal to the data processing system 105. The monitoring attribute 210 can include a binary value to indicate whether the corresponding data point should be monitored, or not monitored. The monitoring attribute 210 can indicate a monitoring interface (e.g., 5 seconds, 60 seconds, change of value). The monitoring attribute 210 can indicate whether the monitored data point should be inverted. The monitoring attribute 210 can indicate that the data point should be monitored only when a user requests for the data point to be monitored. The attributes 210 can include a debugging attribute 210. The debugging attribute 210 can indicate that the data point should be used for debugging errors, warnings, etc. The debugging attribute 210 can indicate that the driver 110 or the debugging application 165 should maintain a record of the data point for debugging purposes.

The driver 110 can read the attributes 210 and determine to distribute the data values of the data point based on the attributes 210. For example, the driver 110 can automatically provide the data point to the applications 165 of the source code 160 based on the attributes. For example, the driver 110 can provide data point values for variables 150 or 155 that include the user interface visualization attribute 210 to the user interface application 165. For example, the driver 110 can provide data point values for variables 150 or 155 that include the notification attribute 210 to the notification application 165. For example, the driver 110 can provide data point values for variables 150 or 155 that include the monitoring attribute 210 to the monitoring application 165. The driver 110 can link a standard interface for data transfer between the applications 165 with the interface provided by the driver 110 to the data points of the energy management device 115.

The attributes 210 can include a block identifier attribute 210. Some communication interfaces 120 include data that can be summarized or transferred in a block of data when the underlying data addresses are consecutive or in a line. The block identifier attribute 210 can include an identifier of a block of information or data points of the energy management device 115. The block identifier attribute 210 can include a value, a name, a string, or other information that uniquely identifies a particular block. The energy management device 115 can have an interface that allows for a set of addresses or data points to be read in a block or written in a block. This can reduce overhead by reading multiple data points of the energy management device 115 at a time or writing to multipole data points of the energy management device 115 at a time. In some implementations, the data point file 130 can indicate blocks for data points. For example, at least one data element or piece of information can link a block identifier with a data point. For example, a column in the data point file 130 can indicate that one or multiple data points of the energy management device 115 include the same block identifiers, indicating that the data points can be block read or block written. In some implementations, a user can edit or update the data point file 130 to identify the block identifiers for one or multiple data points.

In some implementations, the driver 110 can assign blocks to the data points in the data point file 130. For example, the driver 110 can determine if blocks are defined for the data points in the data point file 130, and responsive to determining that data points of the data point file 130 do not have blocks, assign blocks to the data points of the data point file 130. For example, the driver generator 145 can merge consecutive data points into a single block, e.g., data points that have consecutive addresses, address numbers, or address values. Automatically assigning blocks to data points in the data point file 130 that do not have blocks can solve issues where there may be a blank or reserved space and empty data blocks may be written or read.

For example, the driver generator 145 can search the data point file 130 (or the data point file 130 ingested into the database 140) to determine whether data points of the energy management device 115 include data points. For example, the driver generator 145 can determine that a first data point, a second data point, or any number of data points are not assigned a block identifier by the data point file 130. The driver generator 145 can check whether the identified data points include consecutive addresses or addresses that are in a line. For example, the driver generator 145 can identify that a first data point and a second data point have consecutive addresses responsive to determining that an address of the first data point incremented by a predefined number (e.g., 1, 5, 10, etc.) is the second address of the second data point. Responsive to determining that the data points have consecutive addresses, driver generator 145 can generate variables 150 or 155 for the data points that include the same block identifier attributes 210, e.g., the same value, name or number. Responsive to determining that the data point file 130 includes block identifiers for the data points, the driver generator 145 can generate variables 155 or 150 that includes the block identifier attribute 210. For example, the driver generator 145 can include a first variable 150 or 155 and a second variable 150 or 155 that both include the same block identifier attribute 210, as indicated by the data point file 130.

The driver 110 can read the attributes of the variables 150 or 155, and determine to read the corresponding data points of the energy management device 115 in a block or write to the corresponding data points of the energy management device 115 responsive to identifying that the variables 150 or 155 include the same block identifier attribute 210. For example, responsive to receiving a request to read a value of a first data point for a first variable, the driver 110 can check the block identifier attribute 210 of the first variable, and search other variables 150 or 155 for the same block identifier attribute 210, and block read the variables 150 or 155 that include the same block identifier attribute 210. The driver 110 can transmit a request, e.g., a single request, one request, one message, one query message, one query, etc. to the energy management device 115. The request can include the value of the block identifier. For example, the driver 110 can generate, build, or construct the request to include the value of the block identifier attribute 210. The request can be a request to read the block include a first data point, a second data point, or any other number of data points of the energy management device 115. Responsive to the request, the energy management device 115 can transmit the values of the data points in a block, e.g., in a single message. Responsive to transmitting the request to the energy management device 115, the driver 110 can receive the values for the data points in the block from the energy management device 115.

The attributes 210 can include an acquisition rate attribute 210. The driver 110 can use the acquisition rate attribute 210 to reduce irrelevant or unnecessary data traffic. The data point file 130 can include an indication of a rate to read one or multiple data points of the energy management device 115 at. The acquisition time can be parameterized within the data point file 130. A user can set or adjust the acquisition time for each data point. For example, a variable 150 or 155 can include the acquisition rate attribute 210 that indicates that the corresponding data point of the energy management device 115 should be read every 200 milliseconds, every second, every ten seconds, every half minute, every minute, every ten minutes, every hour, etc. The driver 110 can execute to read the data point of the energy management device 115 at the rate defined in the acquisition rate attribute 210. For example, the driver 110 can include a timer or receive a time indication from a timer of the data processing system 105. Based on the timer and the rate, the driver 110 can transmit requests to read the corresponding data point of the energy management device 115 to the energy management device 115 at the defined rate.

The attributes 210 can include a data write attribute 210. The data write attribute 210 can indicate a rate at which to write a value of the data point of the energy management device 115 to the corresponding variable 155 or 150 or to the applications 165. For example, the driver 110 can execute to make the value of the data point available to the variables 150 or 155 and the source code 160 and applications 165 that consume the variables 150 or 155 at the rate indicated by the data write attribute 210. For example, the driver 110 can update or refresh the value of the value attribute 210 at the rate.

The attributes 210 can include an encoding attribute 210. The encoding attribute 210 that indicates how a value of a data point is coded, encoded, masked, etc. The encoding of a data point or the decoding for the data point can be stored or included within the data point file 130 (e.g., the data point file 130 received from the energy management device 115 or the server system 135 or the data point file 130 ingested or stored within the database 140). The encoding or decoding technique can indicate a special word, an error word, bit mask, byte mask, an indication that one data value should be split into two separate data values, an indication that the first 8 bits of a 16 bit value represent a first temperature value while the second 8 bits of the 16 bit value represent a second temperature value, etc.

The driver generator 145 can read the encoding for a data point from the data point file 130, and generate a variable 150 or 155 to include the encoding attribute 210 responsive to reading the encoding. The driver generator 145 can store an indication of the encoding in the encoding attribute 210. The indication can be a bit number, name, or comment. The driver 110 can execute to read the encoding attribute 210 from the variable 155 or 150, and decode the data point values of the corresponding data point received from the energy management device 115 with a decoding technique indicated by the encoding attribute 210. The driver 110 can write the decoded value to the value attribute 210, or provide the decoded value to the source code 160 or the applications 165.

The attributes 210 can include a notification attribute 210. The notification attribute 210 can indicate that a notification should be generated and transmitted to a user interface or to a user device responsive to a condition being met. For example, the notification attribute 210 can indicate that the notification should be generated if a value of a data point exceeds or reaches an upper threshold, or reaches or falls below a lower threshold. The notification attribute 210 can indicate that a notification is generated when a value of the data point changes, or changes by a predefined amount. The notification attribute 210 can indicate a delay time to send a notification. For example, the delay time can indicate a period of time to delay between sending notifications or a time to wait before sending a notification after a condition is met. The notification attribute 210 can include an interval time. The interval time can indicate how frequently notifications should be transmitted, for example, a value of a data point can be reported at an interval. The driver 110 can use the notification attribute to cause notifications to be generated. An application, such as the notification application 165, can read the notification attribute 210 and use the notification attribute to generate notifications.

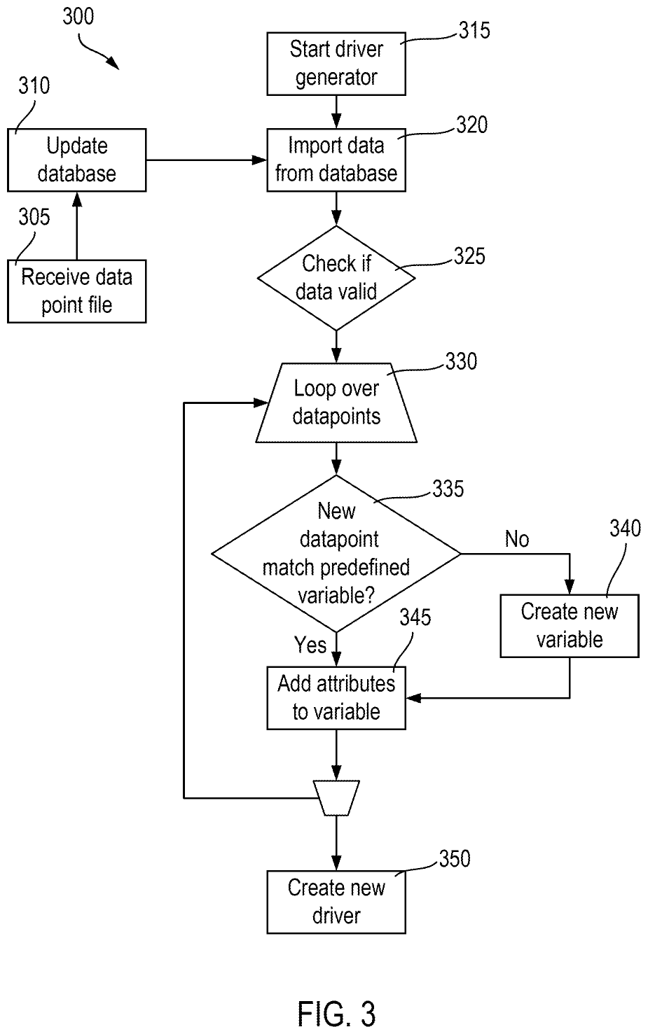

Referring now to FIG. 3, among others, an example method 300 of generating a driver 110 for an energy management device 115 is shown. At least a portion of the method 300 can be performed by the data processing system 105. At least a portion of the method 300 can be performed by the driver generator 145. At least a portion of the method 300 can be performed by the energy management device 115. At least a portion of the method 300 can be performed by the server system 135. At least a portion of the method 300 can be performed by the source code 160. At least a portion of the method 300 can be performed by the application 165. The method 300 can include an ACT 305 of receiving a data point file. The method 300 can include an ACT 310 of updating a database. The method 300 can include an ACT 315 of starting a driver generator. The method 300 can include an ACT 320 of importing data from a database. The method 300 can include an ACT 325 of checking if data is valid. The method 300 can include an ACT 330 of looping over data points. The method 300 can include an ACT 335 of determining if a new data point matches a predefined variable. The method 300 can include an ACT 340 of creating a new variable. The method 300 can include an ACT 345 of adding attributes to a variable. The method 300 can include an ACT 350 of creating a new driver.

At ACT 305, the method 300 can include receiving, by the data processing system 105, the data point file 130. The data processing system 105 can receive the data point file 130 from the energy management device 115. The data processing system 105 can receive the data point file 130 from the server system 135. The data processing system 105 can request or query the energy management device 115 or the server system 135 for the data point file 130. The data processing system 105 can receive the data point file 130 from the energy management device 115 or the server system 135 responsive to a request, or in a message pushed by the energy management device 115 or the server system 135.

At ACT 310, the method 300 can include updating, by the data processing system 105, the database 140. The data processing system 105 can read and translate the data point file 130 into a format of the database 140. The data processing system 105 can ingest the information of the data point file 130. The data processing system 105 can filter out information that the data processing system 105 does not need to generate the driver 110 and the variables 155 or 150.

At ACT 315, the method 300 can include starting, by the data processing system 105, the driver generator 145. The data processing system 105 can activate, trigger, or initiate the driver generator 145. The data processing system 105 can start the driver generator 145 responsive to booting up or exiting a sleep state. The data processing system 105 can start the driver generator 145 responsive to a new data point file 130 being received for a new energy management device 115. The data processing system 105 can strat the driver generator 145 responsive to a new data point file 130 being ingested into the database 140.

At ACT 320, the method 300 can include importing, by the data processing system 105, the database 140. The data processing system 105 can import data from the database 140 by querying the database 140 for the information of the new data point file 130, or by querying the database 140 for a set or list of data points and corresponding descriptions. The data processing system 105 can identify the set or list of data points to be retrieved from the database 140. The data processing system 105 can identify the set or list of data points by identifying the name or type of the energy management device 115. At ACT 325, the method 300 can include checking, by the data processing system 105, if the data imported from the database 140 is valid. The data processing system 105 can compare the data retrieved from the database 140 to one or more formats or standards to verify that the data meets the formats or standards. The data processing system 105 can analyze the imported data to verify that the data is not corrupted. If the data does not meet the standards or is corrupt, the data processing system 105 can exit or stop executing the method 300. If the data does meet the standards and is not corrupt, the data processing system 105 can proceed to the ACT 330.

At ACT 330, the method 300 can include looping, by the data processing system 105, over multiple data points. For example, the data processing system 105 can determine to implement the ACTS 335-345 iteratively, once for each data point imported from the database 140. At ACT 335, the method 300 can include determining, by the data processing system 105, if a new data point matches a predefined variable. For example, the driver generator 145 can compare a name of the data point to names of predefined variable classes in a namespace. If the name of a data point matches the name of a predefined variable class, the method 300 can proceed to ACT 345. If the name of a data point does not match the name of a predefined variable class, the method 300 can proceed to ACT 340. If a match is determined, the driver generator 145 can generate the identified predefined variable as a new object or instance of the predefined variable class. At ACT 340, the method 300 can include creating, by the data processing system 105, a new variable 155. The method 300 can generate an instance of a new variable class responsive to determining that the name of the data point does not match any names of predefined variable classes of the namespace.

At ACT 345, the method 300 can include adding, by the data processing system, attributes to the variable 150 or 155. For example, the driver generator 145 can add or populate attributes of a new variable 150 or a predefined variable 155 generated at ACTS 335 or 340. For example, the driver generator 145 can read the information from the database 140 that describes the data point and write the information to the attributes for the variable 150 or 155. At ACT 350, the data processing system 105 can create a new driver 110. The data processing system can compile or generate the driver 110. The data processing system 105 can add the driver 110 to the source code 110 to run and execute.

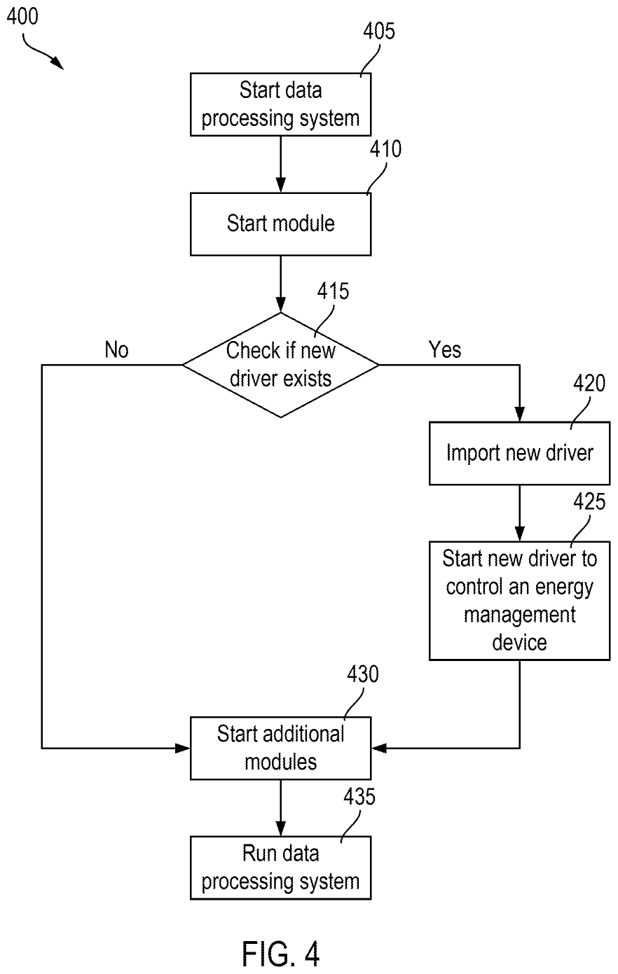

Referring now to FIG. 4, among others, a method 400 of implementing a driver 110 generated by the energy management device 115 is shown. At least a portion of the method 400 can be performed by the data processing system 105. At least a portion of the method 400 can be performed by the driver generator 145. At least a portion of the method 400 can be performed by the energy management device 115. At least a portion of the method 400 can be performed by the server system 135. At least a portion of the method 400 can be performed by the source code 160. At least a portion of the method 400 can be performed by the application 165. The method 400 can include an ACT 405 of starting a data processing system. The method 400 can include an ACT 410 of starting a module. The method 400 can include an ACT 415 of checking if a new driver exists. The method 400 can include an ACT 420 of importing a new driver. The method 400 can include an ACT 425 of starting a new driver to control an energy management device. The method 400 can include an ACT 430 of starting additional modules. The method 400 can include an ACT 435 of running a data processing system.

At ACT 405, the method 400 can include starting a data processing system 105. The data processing system 105 can start responsive to booting up or exiting a sleep state. At ACT 410, the method 410 can include starting, by the data processing system 105, a module. The data processing system 105 can store or include modules that collect and aggregate information for an energy management device 115. For example, the data processing system 105 can include a module specific to the energy management device 115. For example, if multiple energy management devices 115 are coupled with the data processing system 105, the data processing system 105 can implement or run a module or base module for each energy management device 115.

At ACT 415, the method 400 can include checking, by the data processing system 105, if a new driver exists. The data processing system 105 can search a set or group of drivers that are not assigned to a module. The data processing system 105 can generate a driver 110 for each energy management device 115 and assign the drivers to the modules for the respective energy management devices 115. The data processing system 105 can compare a name of the energy management device 115 for which the module started at ACT 410 to the names of the drivers 110. Responsive to identifying a match, the method 400 can proceed to ACT 420. Responsive to not identifying a match, the method 400 can proceed to ACT 430.

At ACT 420, the method 400 can include importing, by the data processing system 105, the new driver. The data processing system 105 can load the driver 110 into the module started at ACT 410 or generate data to connect or link the driver 110 with the module. The data processing system 105 can implement the new driver 110 in the source code 160. At ACT 425, the method 400 can include starting, by the data processing system 105, the driver 110 to operate to control the energy management device 115. The data processing system 105 can run the driver 110 to fulfill the actions of the module, e.g., to interface the module with the energy management device 115 to allow the module to read data points from the energy management device 115 or write information to the energy management device 115.

At ACT 430, the method 400 can include starting additional modules. For example, the data processing system 105 can store and run modules for any type of energy management device 115, e.g., a module for an inverter, a module for a battery, a module for a fire detection and response system, etc. For each module, the method 400 can run the ACTS 415-425. At ACT 435, the method 400 can include running the data processing system 105, e.g., execute the source code 160, the applications 165, etc.

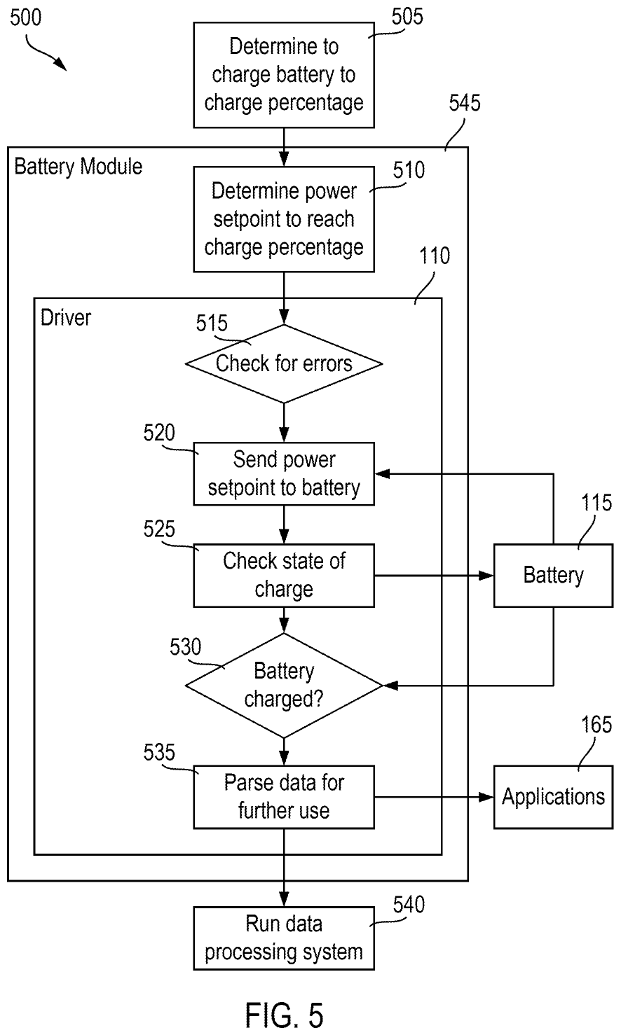

Referring now to FIG. 5, among others, a method 500 of running a driver 110 to control a battery 115 is shown. At least a portion of the method 500 can be performed by the data processing system 105. At least a portion of the method 500 can be performed by the driver generator 145. At least a portion of the method 500 can be performed by the energy management device 115. At least a portion of the method 500 can be performed by the server system 135. At least a portion of the method 500 can be performed by the source code 160. At least a portion of the method 500 can be performed by the application 165. The method 500 can include an ACT 505 of determining to charge a battery to a charge percentage. The method 500 can include an ACT 510 of determining a power setpoint to reach a charge percentage. The method 500 can include an ACT 515 of checking for errors. The method 500 can include an ACT 520 of sending a power setpoint to a battery. The method 500 can include an ACT 525 of checking a state of charge. The method 500 can include an ACT 530 of determining whether a battery is charged. The method 500 can include an ACT 535 of parsing data for further use. The method 500 can include an ACT 540 of running a data processing system.

In the method 500, ACTS 510-535 can be performed by a battery module 545. The battery module 545 can be a piece of software configured to execute to control the battery 115. The data processing system 105 can include one or multiple modules, each module implemented to control a different energy management device 115. The method 500 can be performed for a variety of different types of energy management devices 115. The battery module 545 can include the driver 110, e.g., a driver 110 generated or configured to execute for the battery module 545 to integrate or interface the battery module 545 with the battery 115.

At ACT 505, the method 500 can include determining, by the data processing system 105, to charge a battery 115 to a charge percentage. For example, an application 165 can receive a user input to charge the battery 115 to a particular charge level. For example, an application 165 can run a control algorithm to determine that the battery 115 should be charged to a particular charge level. The charge level can be a particular state of charge or a fully charged level.

At ACT 510, the method 500 can include determining, by the data processing system 105, a power setpoint to reach the charge percentage. The power setpoint can be a setpoint that controls or dictates how much power is used to charge the battery 115. The setpoint can define a rate at which the battery 115 charges. The battery module 545 can run at least one control algorithm or execute at least one function that can determine a power setpoint from a charge percentage. The algorithm run by the battery module 545 can be specific to the type, manufacture, age, or configuration of the battery 115.

At ACT 515, the method 500 can include checking, by the data processing system 105, for errors. For example, the driver 110 can read at least one data point or a set of data points of the battery 115 and provide the values or states of the data points to the battery module 545. The battery module 545 can review or evaluate the values or states to determine whether the battery 115 is experiencing a fault or error, and whether the battery 115 is available to charge. Responsive to determining that the battery 115 is not experiencing any faults or errors, or in response to determining that there are no faults or errors that would prevent the battery 115 from charging, the method 500 can proceed to ACT 520.

At ACT 520, the method 500 can include sending, by the data processing system 105, the power setpoint to the battery 115. For example, the driver 110 can receive the setpoint from the battery module 545. For example, the battery module 545 can write the power setpoint to an attribute of a variable 150 or 155. The driver 110 can, based on the variable 150 or 155, send the power setpoint to the battery 115. For example, the driver 110 can map or link variables 150 or 155 to data points of the battery 115. For example, responsive to reading a power setpoint in a variable 150 or 155, the driver 110 can transmit the power setpoint to the corresponding data point of the battery 115. The driver 110 can transmit the power setpoint in a command, block write command, or message to the battery 115 via the physical interface 120 and according to the protocol 125.

At ACT 525, the method 500 can include checking, by the data processing system 105, the state of charge of the battery 115. The battery 115 can include a data point that represents the state of charge of the battery 115. The driver 110 can read the data point of the battery representing the state of charge, and write a state of charge value to the corresponding variable 150 or 155. The battery module 545 can monitor the state of charge in the variable 150 or 155. Responsive to the state of charge reaching the power setpoint, the battery module 545 can write a new power setpoint (e.g., a setpoint of zero) or stop indicator to a variable 150 or 155, causing the driver 110 to transmit the new power setpoint or stop indicator to the battery 115, causing the battery 115 to stop charging. If the state of charge is not yet reached, the battery module 545 can pause or wait until the state of charge is reached.

At ACT 535, the method 500 can include parsing, by the data processing system 105, data for further use by the applications 165 (e.g., web applications, user interface applications, internal database applications, monitoring applications, notification applications, etc.). For example, the driver 110 can read various data points from the battery 115 and provide the values of the data points to the variables 150 and 155 for the applications 165 to operate or execute on. At ACT 540, the method 500 can include running the data processing system 105. The example, the data processing system 105 can continue running, execute the source code 160, executing applications 165, etc.

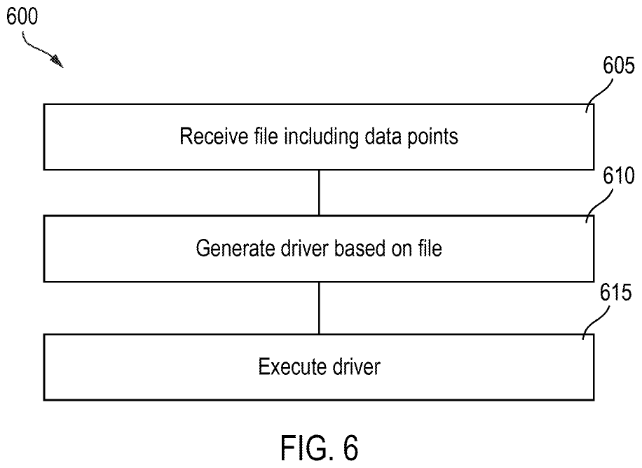

Referring now to FIG. 6, among others, a method 600 of dynamically generating a driver 110 to interface with an energy management device 115. At least a portion of the method 600 can be performed by the data processing system 105. At least a portion of the method 600 can be performed by the driver generator 145. At least a portion of the method 600 can be performed by the energy management device 115. At least a portion of the method 600 can be performed by the server system 135. At least a portion of the method 600 can be performed by the source code 160. At least a portion of the method 600 can be performed by the application 165. The method 600 can include an ACT 605 of receiving a file including data points. The method 600 can include an ACT 610 of generating a driver based on a file. The method 600 can include an ACT 615 of executing a driver.

At ACT 605, the method 600 can include receiving, by the data processing system 105, a file that includes data points. For example, the data processing system 105 can include receiving the data point file 130. The data point file 130 can include indications of data points of a specific energy management device 115. The data point file 130 can store various attributes or characteristics of each data point. The data processing system 105 can receive the data point file 130 from the energy management device 115 or from the server system 135. The data processing system 105 can ingest or store the data of the data point file 130 in a database 140 of the data processing system 105.

At ACT 610, the method 600 can include generating, by the data processing system 105, a driver based on the file. For example, the driver generator 145 can generate the driver 110 based on the data point file 130. The driver generator 145 can generate the driver 110 to map between data points of the energy management device 115 and variables 150 or 155. The driver generator 145 can generate a variable 150 or 155 for each data point of the energy management device 115 indicated by the data point file 130. The driver generator 145 can compare names of the data points included within the data point file 130 to names of predefined variable classes included in a namespace. Responsive to identifying a match, the driver generator 145 can generate or instantiate a predefined variable 150 for the data point. Responsive to not identifying a match, the driver generator 145 can generate a new variable 155 of a new variable class to hold or store information for a data point that is not defined in the namespace and does not correspond to any of the predefined variable classes. The driver generator 145 can populate attributes 210 of each variable 155 or variable 150 with information of the data point file 130.

At ACT 615, the method 600 can include executing, by the data processing system 105, the driver. For example, the driver 110 can be implemented in the source code 160, and when the data processing system 105 executes the source code 160, the driver 110 can be executed. A module configured for the energy management device 115 can include the driver 110, and cause the driver 110 to execute. The driver 110 can read data values from the data points, and store the data values for the data points in the variables 150 or 155. Furthermore, the driver 110 can read values for data points from the variables 150 or 155, and send or transmit the values to the energy management device 115 to store the values in corresponding data points of the energy management device 115.

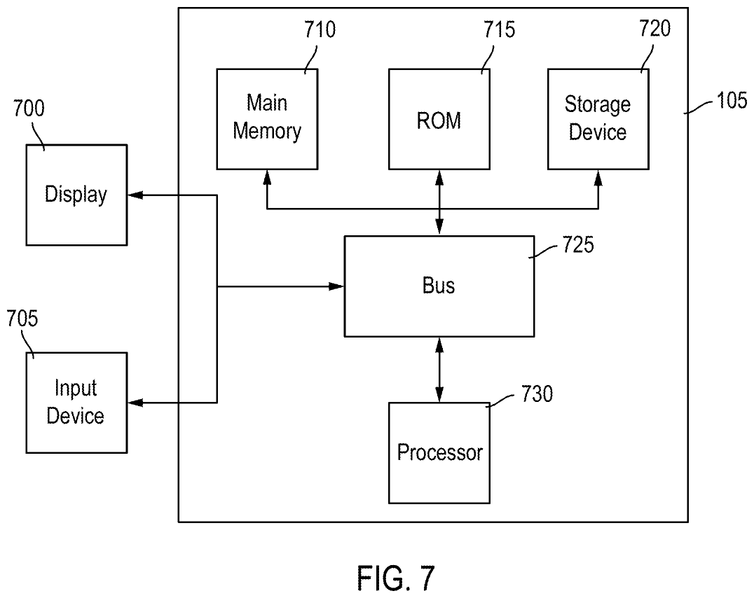

Referring now to FIG. 7, among others, an example block diagram of a data processing system 105 is shown. The data processing system 105 can include or be used to implement a data processing system or its components. The architecture described in FIG. 7 can be used to implement the energy management system 100, the energy management device 115, or the server system 135. The data processing system 105 can include at least one bus 725 or other communication component for communicating information and at least one processor 730 or processing circuit coupled to the bus 725 for processing information. The data processing system 105 can include one or more processors 730 or processing circuits coupled to the bus 725 for processing information. The data processing system 105 can include at least one main memory 710, such as a random access memory (RAM) or other dynamic storage device, coupled to the bus 725 for storing information, and instructions to be executed by the processor 730. The main memory 710 can be used for storing information during execution of instructions by the processor 730. The data processing system 105 can further include at least one read only memory (ROM) 715 or other static storage device coupled to the bus 725 for storing static information and instructions for the processor 730. A storage device 720, such as a solid state device, magnetic disk or optical disk, can be coupled to the bus 725 to persistently store information and instructions.

The data processing system 105 can be coupled via the bus 725 to a display 700, such as a liquid crystal display, or active matrix display. The display 700 can display information to a user. An input device 705, such as a keyboard or voice interface can be coupled to the bus 725 for communicating information and commands to the processor 730. The input device 705 can include a touch screen of the display 700. The input device 705 can include a cursor control, such as a mouse, a trackball, or cursor direction keys, for communicating direction information and command selections to the processor 730 and for controlling cursor movement on the display 700.

The processes, systems and methods described herein can be implemented by the data processing system 105 in response to the processor 730 executing an arrangement of instructions contained in main memory 710. Such instructions can be read into main memory 710 from another computer-readable medium, such as the storage device 720. Execution of the arrangement of instructions contained in main memory 710 causes the data processing system 105 to perform the illustrative processes described herein. One or more processors in a multi-processing arrangement can be employed to execute the instructions contained in main memory 710. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, Python, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices including cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. ACTs, elements and features discussed in connection with one implementation are not intended to be excluded from a similar role in other implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any ACT or element being based on any information, act or element may include implementations where the act or element is based at least in part on any information, act, or element.

Any implementation disclosed herein may be combined with any other implementation or example, and references to “an implementation,” “some implementations,” “one implementation” or the like are not necessarily mutually exclusive and are intended to indicate that a particular feature, structure, or characteristic described in connection with the implementation may be included in at least one implementation or example. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. An energy management system, comprising:
one or more memory devices storing instructions thereon, that, when executed by one or more processors, cause the one or more processors to:
receive a file comprising a plurality of data points of an energy management device coupled to the one or more processors through an interface;
generate a driver based on the plurality of data points of the file; and
execute the driver to read at least one of the plurality of data points or write to at least one of the plurality of data points via the interface.

2. The energy management system of claim 1, wherein the instructions cause the one or more processors to:
generate a namespace, the namespace comprising an indication of a predefined variable;
generate the driver to map a data point of the plurality of data points to an instance of the predefined variable;
execute a software application based on the namespace, the software application configured to operate based on the instance of the predefined variable; and
read a value of the data point from the energy management device via the interface and provide the value to the instance of the predefined variable.

3. The energy management system of claim 1, wherein the instructions cause the one or more processors to:
generate a namespace, the namespace comprising a plurality of predefined variables;
compare a name of a data point of a plurality of data points of the file to a plurality of names of the plurality of predefined variables;
determine, based on the comparison, a match between the name of the data point and a name of a predefined variable of the plurality of predefined variables; and
generate, based on the match, the driver to map the data point of the plurality of data points to an instance of the predefined variable.

4. The energy management system of claim 1, wherein the instructions cause the one or more processors to:
generate the driver to map between the plurality of data points to a plurality of variables, wherein at least variable of the plurality of variables is an object defined based on a class;
wherein the class defines a plurality of attributes for the object that describe the data point.

5. The energy management system of claim 1, wherein the instructions cause the one or more processors to:
generate the driver to map between the plurality of data points and a plurality of variables, wherein:
at least one variable of the plurality of variables is an object defined based on a class, the class defining a plurality of attributes for the object describing a data point of the plurality of data points; and
an attribute of the plurality of attributes comprising a rate to acquire a value of the data point at; and
execute the driver to read the value of the data point at the rate defined in the attribute of the object.

6. The energy management system of claim 1, wherein the instructions cause the one or more processors to:
generate the driver to map between the plurality of data points and a plurality of variables, wherein:
at least one variable of the plurality of variables is an object defined based on a class, the class defining a plurality of attributes for the object describing a data point; and
an attribute of the plurality of attributes comprising a rate to write a value of the data point to a software application; and
execute the driver to write the value of the data point to the software application at the rate defined in the attribute of the object.

7. The energy management system of claim 1, wherein the instructions cause the one or more processors to:
receive the file, the file comprising an indication that a first data point of the plurality of data points and a second data point of the plurality of data points are part of a block;
generate, based on the indication that the first data point and the second data point are part of the block, a plurality of variables comprising:
a first variable, wherein the first variable is a first object defined based on a first class, the first class defining a plurality of first attributes for the first object, the plurality of first attributes comprising a block identifier of the block; and
a second variable, wherein the second variable is a second object defined based on the first class or a second class, the first class or the second class defining a plurality of second attributes for the second object, the plurality of second attributes comprising the block identifier of the block;
execute the driver to:
transmit, via the interface, one request to the energy management device to read the block indicated by the block identifier, the block comprising the first data point and the second data point; and
receive a value of the first data point and a value of the second data point via the interface responsive to the one request.

8. The energy management system of claim 1, wherein the instructions cause the one or more processors to:
search the file to determine that a first data point and a second data point of the plurality of data points do not include a block identifier;
identify that the first data point and the second data point include consecutive addresses;
generate, responsive to an identification that the first data point and the second data point include the consecutive addresses, a first variable for the first data point, the first variable comprising an attribute including an identifier of a block; and
generate, responsive to an identification that the first data point and the second data point include the consecutive addresses, a second variable for the second data point, the second variable comprising an attribute including the identifier of the block.

9. The energy management system of claim 1, wherein the instructions cause the one or more processors to:
compare a name of a data point indicated in the file to a plurality of names of a plurality of predefined variables;
determine, based on the comparison, that there is no match between the name of the data point and the plurality of names the plurality of predefined variables; and
instantiate a variable in a class for the data point responsive to a determination that there is no match between the name of the data point and the plurality of names of the plurality of predefined variables; and
populate a plurality of attributes of the variable based on data of the file for the data point.

10. The energy management system of claim 1, wherein the instructions cause the one or more processors to:
identify an encoding of a value of a data point of a plurality of data points based on the file;
generate an instance of a variable in a class, the class comprising a plurality of attributes;
store an indication of the encoding in an attribute of the plurality of attributes; and
execute the driver to:
read the encoding from the attribute; and
decode the value of the data point based on the encoding.

11. A method, comprising:
receiving, by one or more processing circuits, a file comprising a plurality of data points of an energy management device coupled to the one or more processors through an interface;
generating, by the one or more processing circuits, a driver based on the plurality of data points of the file; and
executing, by the one or more processing circuits, the driver to read at least one of the plurality of data points or write to at least one of the plurality of data points via the interface.

12. The method of claim 11, comprising:
generating, by the one or more processing circuits, a namespace, the namespace comprising an indication of a predefined variable;
generating, by the one or more processing circuits, the driver to map a data point of the plurality of data points to an instance of the predefined variable;
executing, by the one or more processing circuits, a software application based on the namespace, the software application configured to operate based on the instance of the predefined variable; and
reading, by the one or more processing circuits, a value of the data point from the energy management device via the interface and provide the value to the instance of the predefined variable.

13. The method of claim 11, comprising:
generating, by the one or more processing circuits, a namespace, the namespace comprising a plurality of predefined variables;
comparing, by the one or more processing circuits, a name of a data point of a plurality of data points of the file to a plurality of names of the plurality of predefined variables;
determining, by the one or more processing circuits, based on the comparison, a match between the name of the data point and a name of a predefined variable of the plurality of predefined variables; and
generating, by the one or more processing circuits, based on the match, the driver to map the data point of the plurality of data points to an instance of the predefined variable.

14. The method of claim 11, comprising:
generating, by the one or more processing circuits, the driver to map between the plurality of data points to a plurality of variables, wherein at least one variable of the plurality of variables is an object defined based on a class;
wherein the class defines a plurality of attributes for the object that describe the data point.

15. The method of claim 11, comprising:
generating, by the one or more processing circuits, the driver to map between the plurality of data points and a plurality of variables, wherein:
at least one variable of the plurality of variables is an object defined based on a class, the class defining a plurality of attributes for the object describing a data point of the plurality of data points; and
an attribute of the plurality of attributes comprising a rate to acquire a value of the data point at; and
executing, by the one or more processing circuits, the driver to read the value of the data point at the rate defined in the attribute of the object.

16. The method of claim 11, wherein the instructions cause the one or more processors to:
generating, by the one or more processing circuits, the driver to map between the plurality of data points and a plurality of variables, wherein:
at least one variable of the plurality of variables is an object defined based on a class, the class defining a plurality of attributes for the object describing a data point; and
an attribute of the plurality of attributes comprising a rate to write a value of the data point to a software application; and
executing, by the one or more processing circuits, the driver to write the value of the data point to the software application at the rate defined in the attribute of the object.

17. The method of claim 11, wherein the instructions cause the one or more processors to:
receiving, by the one or more processing circuits, the file, the file comprising an indication that a first data point of the plurality of data points and a second data point of the plurality of data points are part of a block;
generating, by the one or more processing circuits, based on the indication that the first data point and the second data point are part of the block, a plurality of variables comprising:
a first variable, wherein the first variable is a first object defined based on a first class, the first class defining a plurality of first attributes for the first object, the plurality of first attributes comprising a block identifier of the block; and
a second variable, wherein the second variable is a second object defined based on the first class or a second class, the first class or the second class defining a plurality of second attributes for the second object, the plurality of second attributes comprising the block identifier of the block;
executing, by the one or more processing circuits, the driver to:
transmit, via the interface, one request to the energy management device to read the block indicated by the block identifier, the block comprising the first data point and the second data point; and
receive a value of the first data point and a value of the second data point via the interface responsive to the one request.

18. The method of claim 11, comprising:
searching, by the one or more processing circuits, the file to determine that a first data point and a second data point of the plurality of data points do not include a block identifier;
identifying, by the one or more processing circuits, that the first data point and the second data point include consecutive addresses;
generating, by the one or more processing circuits, responsive to an identification that the first data point and the second data point include the consecutive addresses, a first variable for the first data point, the first variable comprising an attribute including an identifier of a block; and
generating, by the one or more processing circuits, responsive to an identification that the first data point and the second data point include the consecutive addresses, a second variable for the second data point, the second variable comprising an attribute including the identifier of the block.

19. The method of claim 11, comprising:
comparing, by the one or more processing circuits, a name of a data point indicated in the file to a plurality of names of a plurality of predefined variables;
determining, by the one or more processing circuits, based on the comparison, that there is no match between the name of the data point and the plurality of names the plurality of predefined variables; and
instantiating, by the one or more processing circuits, a variable in a class for the data point responsive to a determination that there is no match between the name of the data point and the plurality of names of the plurality of predefined variables; and
populating, by the one or more processing circuits, a plurality of attributes of the variable based on data of the file for the data point.

20. An energy management system, comprising:
an interface; and
a data processing system comprising one or more memory devices storing instructions thereon and one or more processors to execute the instructions to:
receive a file comprising a plurality of data points of an energy management device coupled to the one or more processors through an interface;
generate a driver based on the plurality of data points of the file; and
execute the driver to read at least one of the plurality of data points or write to at least one of the plurality of data points via the interface.
